(19) United States
(12) Patent Application Publication
(10) Pub. No.: US 2008/0246720 A1
(43) Pub. Date: Oct. 9, 2008

(54) DISPLAY SUBSTRATE AND LIQUID CRYSTAL DISPLAY HAVING THE SAME

(75) Inventors: Gi-chang LEE, Seoul (KR); Jae-beom CHOI, Suwon-si (KR); Won-chang CHUNG, Seoul (KR); Joon-ha PARK, Busan (KR); Cheol-min KIM, Seongnam-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/017,165

(22) Filed: Jan. 21, 2008

(30) Foreign Application Priority Data
Apr. 3, 2007 (KR) 10-2007-0032893

(51) Int. Cl. G09G 3/36

(52) U.S. Cl. 345/96

(57) ABSTRACT

A liquid crystal display includes: a first pixel connected to first and second gate lines, a first positive data line and a first negative data line, and which is supplied with a positive data voltage from the first positive data line when enabled by a first gate-on voltage from the first gate line, and is supplied with a negative data voltage from the first negative data line when enabled by a second gate-on voltage from the second gate line; and a second pixel connected to the first and second gate lines, a second positive data line and a second negative data line, and which is supplied with a negative data voltage from the second negative data line when enabled by the first gate-on voltage and is supplied with a positive data voltage from the second positive data line when enabled by the second gate-on voltage.

This application claims priority to Korean Patent Application No. 10-2007-0032893, filed on Apr. 3, 2007, and all the benefits accruing therefrom under 35 U.S.C. §119, the contents of which in its entirety are herein incorporated by reference.

### BACKGROUND OF THE INVENTION

1. Field of the Invention

The present invention relates to a display substrate and a liquid crystal display having the display substrate, and more particularly, to a display substrate having reduced power consumption and a liquid crystal display having the same.

2. Description of the Related Art

A liquid crystal display includes a first substrate having a plurality of pixel electrodes, a second substrate having a common electrode, a liquid crystal layer having dielectric anisotropy therebetween, a gate driver which drives a plurality of gate lines and a data driver which outputs data signals.

In order to prevent deterioration of the liquid crystal layer, the liquid crystal display utilizes a polarity inversion driving method. Variations of the polarity inversion driving method include frame inversion driving, line inversion driving, column inversion driving and dot inversion driving, for example. In the frame inversion driving method, polarities of data voltages applied to all pixel electrodes of the plurality of pixel electrodes are the same within a given frame. In the line inversion driving method, polarities of data voltages applied to pixel electrodes in a given line of a given frame are identical. In the column inversion driving method, polarities of data voltages applied to pixel electrodes in a given column of a given frame are identical. In the dot inversion driving method, polarities of voltages applied to respective adjacent pixel electrodes are opposite to each other within a given frame.

In each of the polarity inversion driving methods described above, a data voltage having a positive polarity with respect to a common voltage and a data voltage having a negative polarity with respect to the common voltage are applied to respective pixel electrodes in a given frame, and the respective polarities of the data voltages applied to the pixel electrodes are alternately reversed in subsequent frames.

Thus, to perform polarity inversion driving, the data driver sequentially applies data voltages having alternating positive and negative polarities with respect to the common voltage to the data lines of the liquid crystal display.

However, voltage switching operations performed during polarity inversion driving using data voltages having a wide variation in range increases power consumption of the liquid crystal display.

### BRIEF SUMMARY OF THE INVENTION

The present invention provides a display substrate and a liquid crystal display (“LCD”) having the display substrate in which power consumption thereof is effectively reduced.

According to an exemplary embodiment of the present invention, an LCD includes: a first positive data line and a second positive data line, each of which supplies a positive polarity data voltage; a first negative data line and a second negative data line, each of which supplies a negative polarity data voltage; a first pixel connected to first and second gate lines, wherein the first pixel is supplied with a positive polarity data voltage from the first positive data line when the first pixel is enabled by a first gate-on voltage from the first gate line, and the first pixel is supplied with a negative polarity data voltage from the first negative data line when the first pixel is enabled by a second gate-on voltage from the second gate line; and a second pixel connected to the first gate line and the second gate line, wherein the second pixel is supplied with a negative polarity data voltage from the second negative data line when the second pixel is enabled by the first gate-on voltage from the first gate line, and the second pixel is supplied with a positive polarity data voltage from the second data positive line when the second pixel is enabled by the second gate-on voltage from the second gate line.

The first gate-on voltage and the second gate-on voltage are each provided in different frames of a plurality of frames of the liquid crystal display.

An electric potential of the positive polarity data voltage is positive with respect to an electric potential of a direct current common voltage. Further, an electric potential of the negative polarity data voltage is negative with respect to an electric potential of the direct-current common voltage.

The first pixel and the second pixel each includes: a first switching element enabled by the first gate-on voltage; a second switching element enabled by the second gate-on voltage; and a pixel electrode connected to the first switching element and the second switching element, wherein the positive polarity data voltage or the negative polarity data voltage is applied to the pixel electrode through the first switching element or the second switching element.

In an alternative exemplary embodiment, the first pixel and the second pixel each includes: a first switching element enabled by the first gate-on voltage; a second switching element enabled by the second gate-on voltage; a pixel electrode connected to the first switching element and the second switching element, wherein the positive polarity data voltage or the negative polarity data voltage is applied to the pixel electrode through the first switching element or the second switching element; a common electrode opposite to and facing the pixel electrode and to which the direct current common voltage is applied; a liquid crystal layer interposed between the pixel electrode and the common electrode; and a reflection film disposed between the pixel electrode and the liquid crystal layer.

The reflection film overlaps at least a portion of at least one of the first gate line and the second gate line.

The LCD may further include a substrate, wherein the first gate lines and the second gate lines are formed on the substrate, and a light blocking pattern formed on the substrate between adjacent pixel electrodes. At least a portion of the light blocking pattern overlaps either the first positive data line or the first negative data line and either the second positive data line or the second negative data line.

The LCD may further include a black matrix disposed on the common electrode, wherein at least a portion of the black matrix overlaps either the first positive data line or the first negative data line and either the second positive data line or the second negative data line.

In an exemplary embodiment, when the positive polarity data voltage is supplied from the first positive data line, the first negative data line is floated. Further, when the negative polarity data voltage is supplied from the first negative data line, the first positive data line is floated.

The LCD may further include a data driver and a plurality of transfer gates.

The data driver provides the positive polarity data voltage to the first positive data lines and the second positive data lines or the negative data voltage to the first negative data lines and the second negative data lines according to an image signal.

The plurality of transfer gates provides the first positive data line and the second positive data line with the positive polarity data voltage when the positive polarity data voltage is provided from the data driver, and provides the first negative data line and the second negative data line with the negative polarity data voltage when the negative polarity data voltage is provided from the data driver.

In yet another exemplary embodiment of the present invention, the LCD may further include: a third gate line and a fourth gate line; a third pixel connected to the third gate line and the fourth gate line, the first positive data line and the first negative data line, wherein the third pixel is supplied with a positive polarity data voltage from the first positive data line when the third pixel is enabled by a third gate-on voltage from the third gate line, and wherein the third pixel is supplied with a negative polarity data voltage from the first negative data line when the third pixel is enabled by a fourth gate-on voltage from the fourth gate line; and a fourth pixel connected to the third gate line and the fourth gate line, the second positive data line and the second negative data line, wherein the fourth pixel is supplied with a negative polarity data voltage from the second negative data line when the third pixel is enabled by a third gate-on voltage from the third gate line, and wherein the fourth pixel is supplied with a positive polarity data voltage from the second positive data line when the fourth pixel is enabled by a fourth gate-on voltage from the fourth gate line.

In still another exemplary embodiment, the LCD may further include a third gate line and a fourth gate line; a third pixel connected to the third gate line and the fourth gate line, the first positive data line and the first negative data line, wherein the third pixel is supplied with a negative polarity data voltage from the first negative data line when the third pixel is enabled by a third gate-on voltage from the third gate line, and wherein the third pixel is supplied with a positive polarity data voltage from the first positive data line when the third pixel is enabled by a fourth gate-on voltage from the fourth gate line; and a fourth pixel connected to the third gate line and the fourth gate line, the second positive data line and the second negative data line, wherein the fourth pixel is supplied with a positive polarity data voltage from the second positive data line when the fourth pixel is enabled by a third gate-on voltage from the third gate line, and wherein the fourth pixel is supplied with a negative polarity data voltage from the second negative data line when the fourth pixel is enabled by a fourth gate-on voltage from the fourth gate line.

According to another exemplary embodiment of the present invention, a display substrate includes: an insulating substrate; a first gate line and a second gate line; a first data line and a second data line formed on the insulating substrate and each crossing the first and second gate lines; a first thin film transistor connected to the first gate line and the first data line and including a first drain electrode; a second thin film transistor coupled to the second gate line and the second data line and including a second drain electrode; a first pixel electrode connected to the first drain electrode and the second drain electrode; and a reflection film. At least a portion of the reflection film overlaps at least a portion the first pixel electrode.

The reflection film may further overlap at least a portion of one of the first gate line and the second gate line.

The first pixel electrode is disposed between the first data line and the second data line.

The display substrate may further include a light blocking pattern formed on the insulating substrate, wherein at least a portion of the light blocking pattern overlaps at least a portion of one of the first data line and the second data line.

When a data voltage is applied to the first data line, the second data line is floated.

The display substrate may further include: a third data line and a fourth data line; a third thin film transistor connected to the first gate line and the third data line and having a third drain electrode; a fourth thin film transistor connected to the second gate line and the fourth data line and having a fourth drain electrode; and a second pixel electrode connected to the third drain electrode and the fourth drain electrode.

The second pixel electrode is disposed between the third data line and the fourth data line.

The display substrate may further include a light blocking pattern formed on the insulating substrate disposed between the first pixel electrode and the second pixel electrode, wherein at least a portion of the light blocking pattern overlaps at least a portion of one of the first data line and the second data line and one of the third data line and the fourth data line.

### BRIEF DESCRIPTION OF THE DRAWINGS

The above and other aspects, features and advantages of the present invention will become more readily apparent by describing in further detail exemplary embodiments thereof with reference to the accompanying drawings, in which:

FIG. 1 is a block diagram of a liquid crystal display (“LCD”) according to an exemplary embodiment of the present invention;

FIG. 2A is a signal timing diagram illustrating a gate signal output from a gate driver according to the exemplary embodiment of the present invention in FIG. 1;

FIGS. 2B through 2E are schematic circuit diagrams illustrating an operation of the LCD according to the exemplary embodiment of the present invention in FIG. 1;

FIGS. 3A and 3B are schematic circuit diagrams illustrating an operation of an LCD according to another exemplary embodiment of the present invention;

FIG. 4A is a signal timing diagram illustrating a gate signal output from a gate driver of an LCD according to still another exemplary embodiment of the present invention;

FIGS. 4B and 4C are schematic circuit diagrams illustrating an operation of the LCD according to the exemplary embodiment of the present invention in FIG. 4A;

FIG. 5A is a partial schematic circuit diagram of an LCD including transfer gates according to an exemplary embodiment of the present invention;

FIG. 5B is a signal timing diagram illustrating operations of the transfer gates according to the exemplary embodiment of the present invention in FIG. 5A;

FIG. 6 is a plan layout view of a display substrate and an LCD including the display substrate according to an exemplary embodiment of the present invention;

FIG. 7 is a partial cross-sectional view taken along line VII-VII′ of the display substrate and the LCD including the same according to the exemplary embodiment of the present invention in FIG. 6; and

FIG. 8 is a partial cross-sectional view taken along the line VIII-VIII′ of the display substrate and the LCD including the same according to the exemplary embodiment of the present invention in FIG. 6.

### DETAILED DESCRIPTION OF THE INVENTION

The invention will now be described more fully hereinafter with reference to the accompanying drawings, in which exemplary embodiments of the invention are shown. The present invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including,” when used in this specification, specify the presence of stated features, regions, integers, steps, operations, elements and/or components, but do not preclude the presence or addition of one or more other features, regions, integers, steps, operations, elements, components and/or groups thereof.

Furthermore, relative terms, such as “lower” or “bottom” and “upper” or “top” may be used herein to describe one element's relationship to other elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on the “upper” side of the other elements. The exemplary term “lower” can, therefore, encompass both an orientation of “lower” and “upper,” depending upon the particular orientation of the figure. Similarly, if the device in one of the figures were turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning which is consistent with their meaning in the context of the relevant art and the present disclosure, and will not be interpreted in an idealized or overly formal sense unless expressly so defined herein.

Exemplary embodiments of the present invention are described herein with reference to cross section illustrations which are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes which result, for example, from manufacturing. For example, a region illustrated or described as flat may, typically, have rough and/or nonlinear features. Moreover, sharp angles which are illustrated may be rounded. Thus, the regions illustrated in the figures are schematic in nature and their shapes are not intended to illustrate the precise shape of a region and are not intended to limit the scope of the present invention.

The present invention will now be described in further detail with reference to the accompanying drawings.

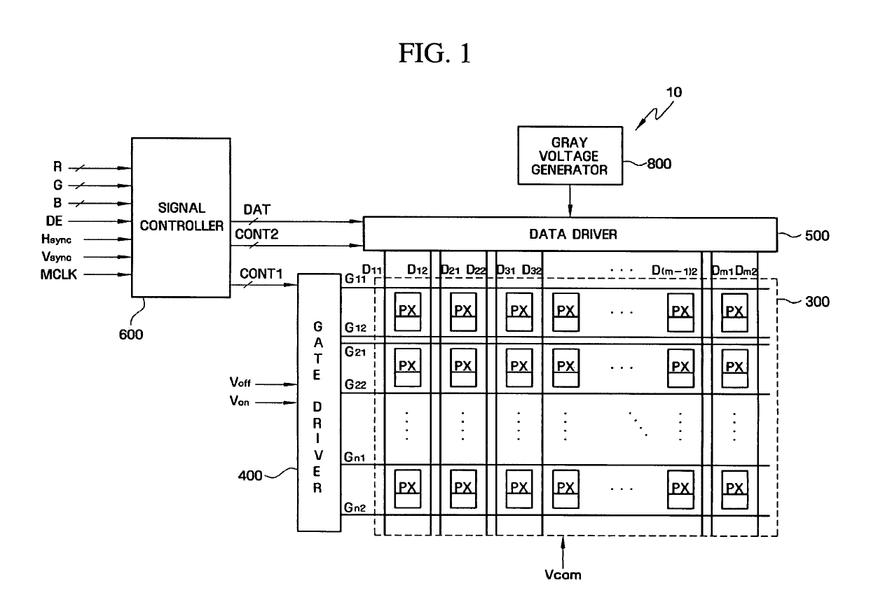

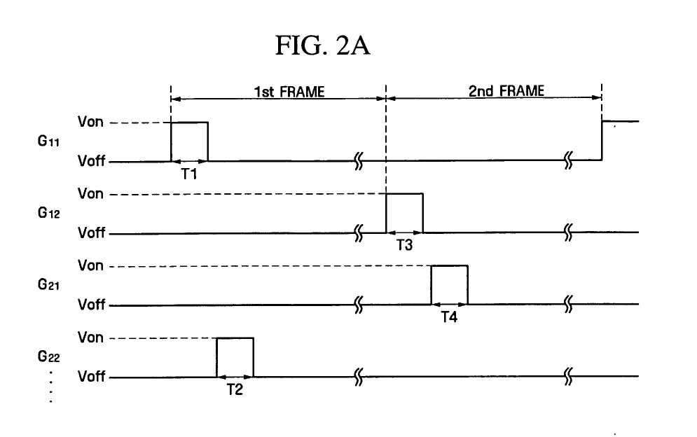

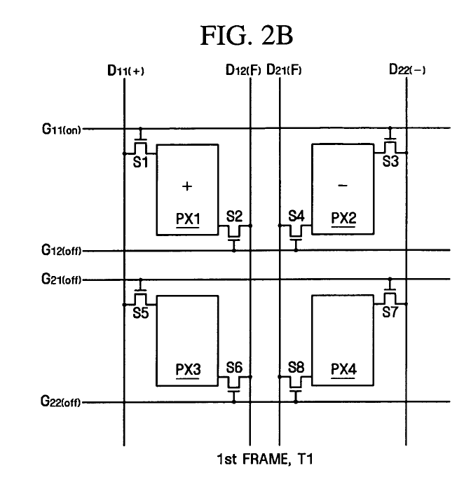

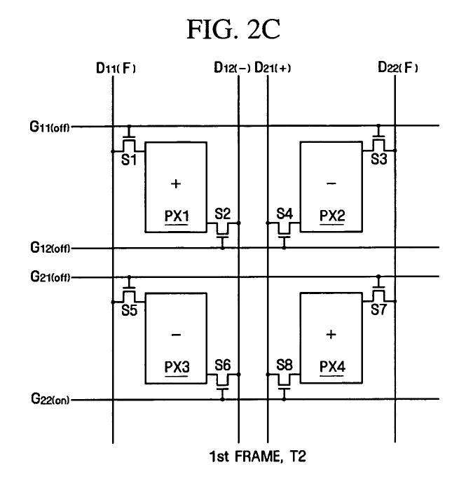

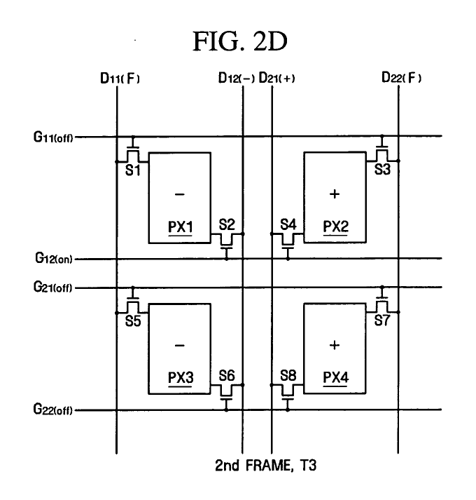

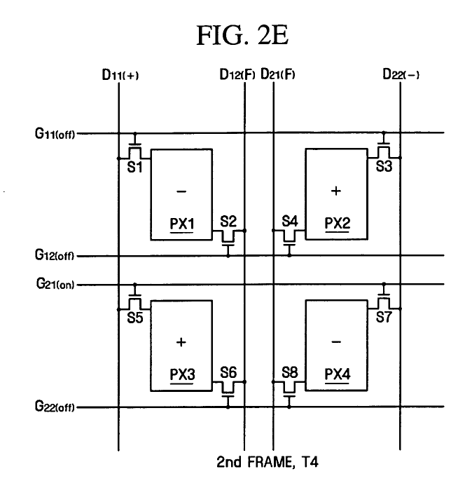

FIG. 1 is a block diagram of a liquid crystal display (“LCD”) according to an exemplary embodiment of the present invention, FIG. 2A is a signal timing diagram illustrating a gate signal output from a gate driver according to the exemplary embodiment of the present invention in FIG. 1, and FIGS. 2B through 2E are schematic circuit diagrams illustrating an operation of the LCD according to the exemplary embodiment of the present invention in FIG. 1.

Referring to FIG. 1, the LCD 10 includes a liquid crystal panel 300, a gate driver 400, a data driver 500, a signal controller 600 and a gray voltage generator 800.

The liquid crystal panel 300 receives a direct current common voltage Vcom from a power supply (not shown) and includes a plurality of display signal lines G₁₁-Gₙ₂ and D₁₁-Dₘ₂ and pixels PX arranged in a substantially matrix pattern and connected to the plurality of display signal lines G₁₁-Gₙ₂ and D₁₁-Dₘ₂.

The plurality of display signal lines G₁₁-Gₙ₂ and D₁₁-Dₘ₂ includes a plurality of gate lines G₁₁-Gₙ₂ which transmit gate signals and a plurality of data lines D₁₁-Dₘ₂ which transmit data signals. Each pixel PX of the plurality of pixels PX is connected to a pair of respective gate lines of the plurality of gate lines G₁₁-Gₙ₂. For example, each pixel PX of a first pixel column is connected to a pair of respective gate lines G₁₁ and G₁₂, as shown in FIG. 1. In addition, each pixel PX of the plurality of pixels PX is connected to a pair of respective data lines of the plurality of data lines D₁₁-Dₘ₂. For example, each pixel PX of a first pixel row is connected to a pair of respective data lines D₁₁ and D₁₂, as shown in FIG. 1. Thus, each pixel PX is connected to a pair of respective gate lines G₁₁-Gₙ₂ and a pair of respective data lines D₁₁-Dₘ₂.

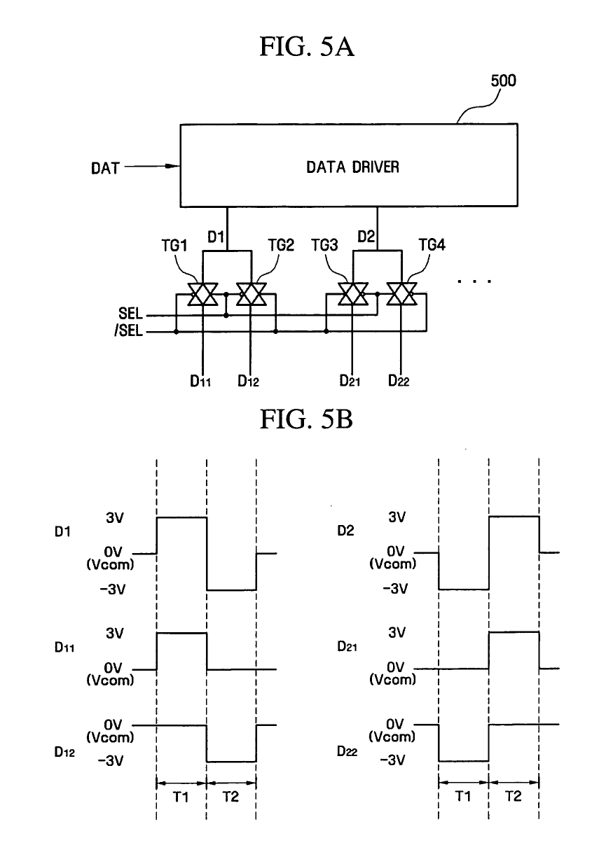

The plurality of gate lines G₁₁-Gₙ₂ extends in a first direction substantially in a row direction and individual gate lines of the plurality of gate lines G₁₁-Gₙ₂ are substantially parallel to each other, while the plurality of data lines D₁₁-Dₘ₂ extends in a second direction substantially in a column direction and perpendicular to the first direction and individual data lines of the plurality of data lines D₁₁-Dₘ₂ are substantially parallel to each other, as shown in FIG. 1. The liquid crystal panel 300 will be described in further detail later with reference to FIGS. 5 through 8.

Still referring to FIG. 1, the signal controller 600 receives red (R), green (G) and blue (B) image data signals from an outside graphics controller (not shown), and a plurality of control signals V_{sync}, H_{sync}, MCLK and DE for controlling display of the R, G and B image data signals. The signal controller 600 generates a gate control signal CONT1 and a data control signal CONT2 based on the plurality of control signals V_{sync}, H_{sync}, MCLK and DE and generates an image signal DAT based on the R, G and B image data signals. The signal controller 600 provides the generated image signal DAT and the data control signal CONT2 to the data driver 500 and provides the gate control signal CONT1 to the gate driver 400.

The plurality of control signals V_{sync}, H_{sync}, MCLK and DE includes a vertical synchronization signal V_{sync}, a horizontal synchronization signal H_{sync} a main clock signal MCLK and a data enable signal DE.

The gray voltage generator 800 generates a plurality of gray voltages and supplies the data driver 500 with the generated plurality of gray voltages. The gray voltage generator 800 may include a resistor string, for example, but is not limited thereto.

The data driver 500 operates in response to the data control signal CONT2 supplied from the signal controller 600 to select a positive polarity data voltage or a negative polarity data voltage corresponding to the image signal DAT from among the plurality of gray voltages supplied from the gray voltage generator 800 and applies the selected positive polarity data voltage or the negative polarity data voltage to the plurality of data lines D₁₁-Dₘ₂. The data control signal CONT2 includes a horizontal synchronization start signal (not shown) for initiating operation of the data driver 500 and an output instruction signal (not shown) for instructing an image data voltage to be output, for example, but is not limited thereto.

The gate driver 400 receives the gate control signal CONT1 from the signal controller 600 and applies the gate control signal CONT1 to the plurality of gate lines G₁₁-Gₙ₂. The gate signal CONT1 may include, for example, a gate-on voltage Vₒₙ and a gate-off voltage V_{off} supplied from an outside device (not shown), but is not limited thereto. An exemplary embodiment of the present invention includes 2n gate lines G₁₁-Gₙ₂, for example, as shown in FIG. 1, and the gate-on voltage Vₒₙ is sequentially applied to n gate lines within one frame, while the gate-on voltage Vₒₙ is then sequentially applied to the remaining n gate lines in a subsequent adjacent next frame.

The gate control signal CONT1 is a signal which controls operation of the gate driver 400, and includes a vertical synchronization start signal (not shown) for initiating the operation of the gate driver 400, a gate clock signal (not shown) for controlling output timing of the gate-on voltage Vₒₙ and an output enable signal (not shown) for controlling a pulse width of the gate-on voltage Vₒₙ, for example, but is not limited thereto.

A timing sequence of gate signals output from the gate driver 400 will now be described in further detail with reference to FIG. 2A.

In a 1st frame, the gate-on voltage Vₒₙ is applied to a first gate line G₁₁ during a first time period T1 and the gate-on voltage Vₒₙ is then applied to a fourth gate line G₂₂ during a second time period T2 subsequent to the first time period T1, as shown in FIG. 2A. During the first time period T1 and the second time period T2, the gate-off voltage V_{off} is applied to a second gate line G₁₂ and a third gate line G₂₁.

In a 2nd frame, the gate-on voltage Vₒₙ is applied to the second gate line G₁₂ during a third time period T3 and the gate-on voltage Vₒₙ is then applied to the third gate line G₂₁ during a fourth time period T4. During the third time period T3 and the fourth time period T4, the gate-off voltage V_{off} is applied to the first and fourth gate lines G₁₁ and G₂₂, respectively,.

When gate signals are output from the gate driver 400 as described above, pixels PX operate as described in further detail below. More specifically, an operation of gate signal signals applied to pixels PX will now be described in further detail with reference to FIGS. 2A through 2E. For purposes of explanation, four adjacent pixels PX1, PX2, PX3 and PX4 of the pixels PX of the liquid crystal panel 300 will be discussed. Further, FIGS. 2B through 2E illustrate electric potentials of first through fourth data lines D₁₁, D₁₂, D₂₁ and D₂₂, respectively, and polarities of the first through fourth pixels PX1, PX2, PX3 and PX4, respectively.

Hereinafter, a case in which the gate-on voltage Vₒₙ is applied to a respective gate line will be indicated by appending a designation “(on)” to a label of the respective gate line, e.g., “G₁₁₍ₒₙ₎” indicates that the gate-on voltage Vₒₙ is applied to gate line G₁₁ in the associated figure. Conversely, a case in which the gate-off voltage Voff is applied to a respective gate line will be indicated by appending a designation “(off)” to a label of the respective gate line, e.g., “G_{11(off)}” indicates that the gate-off voltage Voff is applied to gate line G₁₁ in the associated figure. Furthermore, positive polarity and negative polarity data voltages applied to data lines will be indicated by positive (“+”) signs and negative (“−”) signs, respectively, in a respective data line label, e.g., D₁₁₍₊₎ indicates that a positive polarity data voltage is applied to data line D₁₁ in the associated figure. Finally, a case in which a data line is floated will be indicated by the letter “F”, e.g., “D_{11(F)}” indicates that data line D₁₁ is floated in the associated figure.

Referring to FIG. 2B, the gate-on voltage Vₒₙ is applied to a first gate line G₁₁ during the first time period T1 of the 1st frame, and the gate-off voltage V_{off} is applied to a second gate line G₁₂, a third gate line G₂₁ and a fourth gate line G₂₂ during the first time period T1 of the 1st frame. As a result, a first switching element S1 and a third switching element S3 are turned on. Thus, data voltages are applied to the first pixel PX1 and the second pixel PX2 from first data line D₁₁ and fourth data line D₂₂, respectively. Further, according to an exemplary embodiment of the present invention as shown in FIG. 2B, a positive polarity data voltage is applied to the first data line D₁₁ and a negative polarity data voltage is applied to the fourth data line D₂₂ during the first time period T1 of the 1st frame.

As a result, the positive polarity data voltage is applied to the first pixel PX1 while the negative polarity data voltage is applied to the second pixel PX2, as shown in FIG. 2B. The second and third data lines D₁₂ and D₂₁, respectively, are floated, since a second switching element S2, a fourth switching element S4, a sixth switching element S6 and an eight switching element S8 are off during the first time period T1 of the 1st frame.

In an exemplary embodiment, an electric potential of the positive polarity data voltage is positive with respect to an electric potential of the direct-current common voltage Vcom (FIG. 1), and an electric potential of the negative polarity data voltage is negative with respect to the electric potential of the direct-current common voltage Vcom.

Referring to FIG. 2C, the gate-on voltage Vₒₙ is applied to the fourth gate line G₂₂ during the second time period T2 of the 1st frame and the gate-off voltage V_{off} is applied to the first gate line G₁₁, the second gate line G₁₂ and the third gate line G₂₁ during the second time period T2. Accordingly, the sixth switching element S6 and the eighth switching element S8 are turned on. Therefore, data voltages are applied to the third pixel PX3 and the fourth pixel PX4 through the second data line D₁₂ and the third data line D₂₁, respectively during the second time period T2 of the 1st frame. In an exemplary embodiment, a negative polarity data voltage is applied to the second data line D₁₂ and a positive data voltage is applied to the third data line D₂₁. Accordingly, the negative (−) polarity data voltage is applied to the third pixel PX3 while the positive (+) polarity data voltage is applied to the fourth pixel PX4 during the second time period T2 of the 1st frame. Further, the first and fourth data lines D₁₁ and D₂₂, respectively, are floated, since the first switching element S1, the third switching element S3, a fifth switching element S5 and a seventh switching element S7 are off during the second time period T2 of the 1st frame.

Referring to FIG. 2D, the gate-on voltage Vₒₙ is applied to the second gate line G₁₂ during the third time period T3 of the 2nd frame. Accordingly, the second switching element S2 and the fourth switching element S4 are turned on. Therefore, data voltages are applied to the first pixel PX1 and the second pixel PX2 from the second data line D₁₂ and the third data line D₂₁, respectively. In an exemplary embodiment, a negative polarity data voltage is applied to the second data line D₁₂ and a positive data voltage is applied to the third data line D₂₁. Accordingly, the negative polarity data voltage is applied to the first pixel PX1 while the positive polarity data voltage is applied to the second pixel PX2 during the third time period T3 of the 2nd frame. The first and fourth data lines D₁₁ and D₂₂, respectively, are floated, since the first, third, fifth and seventh switching elements S1, S3, S5 and S7, respectively, are off during the third time period T3 of the 2nd frame.

Referring to FIG. 2E, the gate-on voltage Vₒₙ is applied to the third gate line G₂₁, during the fourth time period T4 of the 2nd frame. Accordingly, the fifth switching element S5 and the seventh switching element S7 are turned on. Therefore, data voltages are applied to the third and fourth pixels PX3 and PX4, respectively. In an exemplary embodiment, a positive polarity data voltage is applied to the first data line D₁₁ and a negative polarity data voltage is applied to the fourth data line D₂₂. Accordingly, the positive polarity data voltage is applied to the third pixel PX3 while the negative polarity data voltage is applied to the fourth pixel PX4 during the fourth time period T4 of the 2nd frame. Further, the second and third data lines D₁₂ and D₂₁, are floated, since the second, fourth, sixth and eighth switching elements S2, S4, S6 and S8, respectively, are off during the fourth time period T4 of the 2nd frame.

As described above, a dot inversion driving method in which voltages having opposite polarities are alternately applied to adjacent pixels PX is performed in consecutive frames of an LCD according to an exemplary embodiment of the present invention. Further, a data voltage having a positive polarity with respect to a direct current common voltage Vcom and a data voltage having a negative polarity with respect to the direct current common voltage Vcom are alternately applied to the pixels PX. Since first and third data lines D₁₁ and D₂₁, respectively, to which the positive polarity data voltage is applied, and second and fourth data lines D₁₂ and D₂₂, respectively, to which the negative polarity data voltage is applied, are separate and distinct from each other, a variation in voltage between each of the respective positive or negative data lines is small, thereby effectively reducing power consumption of the LCD device.

In addition, when the positive polarity data voltages are applied to the first and third data lines D₁₁ and D₂₁, respectively, without being applied to the second and fourth data lines D₁₂ and D₂₂, respectively, a power consumption required when applying the data voltage to the second and fourth data lines D₁₂ and D₂₂, respectively, is effectively reduced. Likewise, when the negative polarity data voltages are applied to the second and fourth data lines D₁₂ and D₂₂, respectively, without being applied to the first and third data lines D₁₁ and D₂₁, respectively, a power consumption required when applying the data voltage to the first and third data lines D₁₁ and D₂₁, respectively, is effectively reduced.

In alternative exemplary embodiments of the present invention which will be described in further detail later, a gate signal supplied from the gate driver 400 may be provided in a manner different than as described above with reference to FIGS. 2A through 2E. In addition, unlike in the previous exemplary embodiment in which data voltages are selectively applied to some data lines while other data lines are floated, positive and/or negative polarity data voltages may be simultaneously applied to all data lines. Furthermore, negative polarity data voltages may be applied to the first and third data lines D₁₁ and D₂₁ while positive polarity data voltages may be applied to the second and fourth data lines D₁₂ and D₂₂ in alternative exemplary embodiments of the present invention. Alternatively, the same polarity data voltages may be applied to each respective pair of first and fourth data lines D₁₁ and D₂₂, respectively, and second and third data lines D₁₂ and D₂₁, respectively.

Finally, in an exemplary embodiment of the present invention, the gate driver 400 and/or the data driver 500 may be directly mounted on the liquid crystal panel assembly 300 with a plurality of integrated circuit (“IC”) chips (not shown), or may be mounted on a flexible printed circuit (“FPC”) film (not shown) attached to the liquid crystal panel assembly 300 in a tape carrier package (“TCP”) form, for example, but alternative exemplary embodiments are not limited thereto. For example, in alternative exemplary embodiments the gate driver 400 and/or the data driver 500 may be integrated in the liquid crystal panel assembly 300 together with the display signal lines G₁₁-G₁₂ and D₁₁-Dₘ₂ by a system on glass (“SOG”) method, but are not limited thereto.

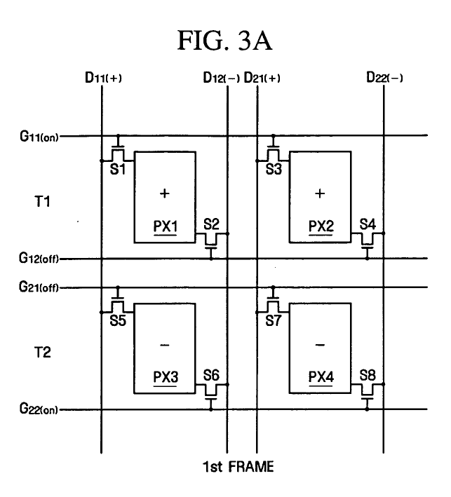

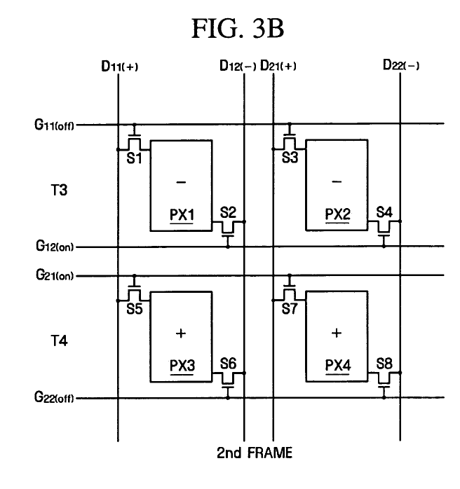

Hereinafter, an LCD according to another exemplary embodiment of the present invention will be described in further detail with reference to FIGS. 2A, 3A and 3B. FIGS. 3A and 3B are schematic circuit diagrams illustrating an operation of an LCD according to another exemplary embodiment of the present invention. The same reference numbers refer to the same or like components in FIGS. 2A through 2E and FIGS. 3A and 3B; thus repetitive descriptions thereof will hereinafter be omitted. Positions of the switching elements S3 and S4, respectively, of the second pixel PX2, and switching elements S7 and S8, respectively, of the fourth pixel PX4 are different, however, than in FIGS. 2B through 2E, as shown in FIGS. 3A and 3B and described in further detail below.

In the following description, it is assumed that the same gate signal shown in FIG. 2A is applied to the respective first, second, third and fourth gate lines G₁₁, G12, G21 and G₂₂, respectively, in FIGS. 3A and 3B.

Referring to FIG. 3A, in the 1st frame, the first and fourth gate lines G₁₁ and G₂₂, respectively, are sequentially turned on (FIG. 2A), and positive polarity data voltages are thereby applied to the first and second pixels PX1 and PX2, respectively, through the first and third switching elements S1 and S3, respectively, during the first time period T1. Negative polarity data voltages are applied to the third and fourth pixels PX3 and PX4, respectively, through the sixth and eighth switching elements S6 and S8, respectively, during the second time period T2, as shown in FIG. 3A.

Referring to FIG. 3B, in the 2nd frame the second and third gate lines G₁₂ and G₂₁, respectively, are sequentially turned on (FIG. 2A), and negative polarity data voltages are thereby applied to the first and second pixels PX1 and PX2, respectively, through the second and fourth switching elements S2 and S4, respectively, during the third time period T3. Positive polarity data voltages are applied to the third and fourth pixels PX3 and PX4, respectively, through the fifth and seventh switching elements S5 and S7, respectively, during the fourth time period T4.

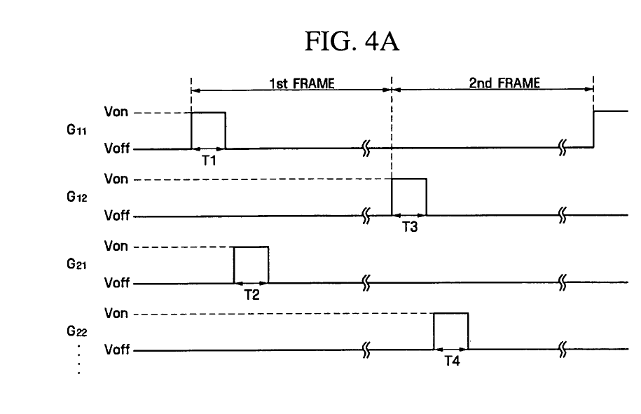

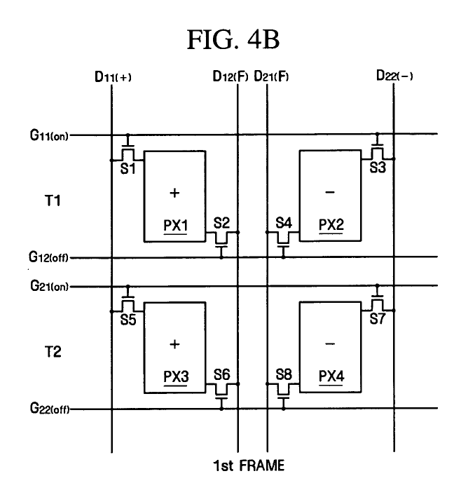

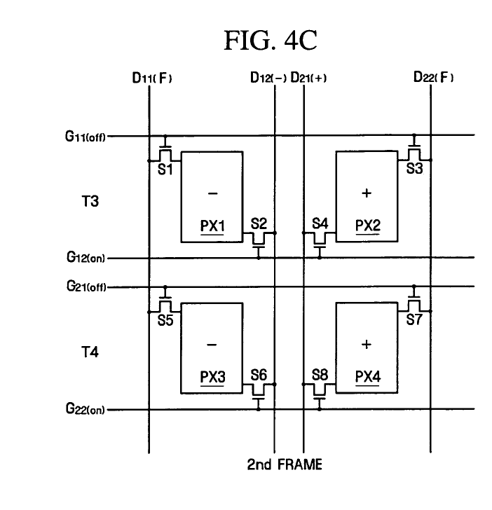

Therefore, in the exemplary embodiment shown in FIGS. 2A, 4A and 4B, the LCD is driven by a line inversion method. Therefore, since the first and third data lines D₁₁ and D₂₁, respectively, to which the positive polarity data voltage is applied, and the second and fourth data lines D₁₂ and D₂₂, respectively, to which the negative polarity data voltage is applied, are separate and distinct from each other, voltage switching operations between each of the respective data lines occurs within a small voltage variation range, thereby substantially reducing power consumption of the LCD. Furthermore, while data voltages are applied to a pair of respective data lines, no data voltage is applied to the other pair of data lines, and power consumption may thereby be further reduced.

An LCD according to still another exemplary embodiment of the present invention will now be described in further detail with reference to FIGS. 4A through 4C. FIG. 4A is a signal timing diagram illustrating a gate signal output from a gate driver of an LCD according to still another exemplary embodiment of the present invention, and FIGS. 4B and 4C are schematic circuit diagrams illustrating an operation of the LCD according to the exemplary embodiment of the present invention in FIG. 4A.

Referring to FIG. 4A, in a 1st frame, the gate-on voltage Vₒₙ is applied to a first gate line G₁₁ during a first time period T1 and the gate-on voltage Vₒₙ is then applied to a third gate line G₂₁ during a second time period T2 subsequent to the first time period T1. During the first time period T1 and the second time period T2, the gate-off voltage V_{off} is applied to a second gate line G₁₂ and a fourth gate line G₂₂.

In a 2nd frame, the gate-on voltage Vₒₙ is applied to a second gate line G₁₂ during a third time period T3 and the gate-on voltage Vₒₙ is then applied to a fourth gate line G₂₂ during a fourth time period T4. During the third time period T3 and the fourth time period T4, the gate-off voltage V_{off} is applied to the first and third gate lines G₁₁ and G₂₁, respectively, as shown in FIG. 4A.

Referring to FIG. 4B, in the 1st frame a positive polarity data voltage is applied to the first pixel PX1 through a first switching element S1 and a negative polarity data voltage is applied to the second pixel PX2 through a third switching element S3 during the first time period T1. During the second time period T2 of the 1st frame, a positive polarity data voltage is applied to the third pixel PX3 through a fifth switching element S5 and a negative polarity data voltage is applied to the fourth pixel PX4 through a seventh switching element S7.

Referring to FIG. 4C, in the 2nd frame a negative polarity data voltage is applied to the first pixel PX1 through a second switching element S2 and a positive polarity data voltage is applied to the second pixel PX2 through a fourth switching element S4 during the third time period T3. During the fourth time period T4 of the 2nd frame, a negative polarity data voltage is applied to the third pixel PX3 through a sixth switching element S6 and a positive polarity data voltage is applied to the fourth pixel PX4 through an eighth switching element S8.

Thus, in the exemplary embodiment of the present invention shown in FIGS. 4A through 4C, the LCD is driven by a column inversion method. Therefore, since the first and third data lines D₁₁ and D₂₁, respectively, to which the positive polarity data voltages are applied, and second and fourth data lines D₁₂ and D₂₂, respectively, to which the negative polarity data voltages are applied, are separate and distinct from each other, voltage switching operations between each of the respective data lines occurs within a small voltage variation range, thereby reducing power consumption of the LCD. In addition, when data voltages are applied to a pair of data lines, no data voltages are be applied to the other pair of data lines, further reducing power consumption.

A data driver of an LCD according to an exemplary embodiment of the present invention in which positive and/or negative polarity data voltages are applied to a respective pair of data lines while floating the other pair of data lines will hereinafter be described in further detail with reference to FIGS. 5A and 5B. For ease of description, the exemplary embodiment will be described with respect to an LCD operating by the dot inversion driving method described in greater detail above with respect to the exemplary embodiment of the present invention in FIGS. 2A through 2E, and repetitive descriptions of the same or like components will be omitted below. It will be understood, however, that the data driver described in further detail below is not limited to the exemplary embodiment of the present invention in FIGS. 2A through 2E. Rather, the data driver described below in reference to FIGS. 5A and 5B is applicable to all exemplary embodiments of the present invention described herein.

FIG. 5A is a partial schematic circuit diagram of an LCD including transfer gates according to an exemplary embodiment of the present invention, and FIG. 5B is a signal timing diagram illustrating operation of the transfer gates according to the exemplary embodiment of the present invention in FIG. 5A. In the following description, it is assumed that a common voltage Vcom is 0 V, for example, but alternative exemplary embodiments are not limited thereto.

Referring to FIG. 5A, a data driver 500 receives an image signal DAT from a signal controller 600 (FIG. 1) and supplies a data voltage corresponding to the image signal DAT to a first original data line D1 and a second original data line D2.

As shown in FIG. 5B, a data voltage applied to the first original data line D1 during a first time period T1 is a positive polarity data voltage, e.g., 3 V, but is not limited thereto, with respect to the common voltage Vcom, e.g., 0 V, while a data voltage applied to the first original data line D1 during a second time period T2 is a negative polarity data voltage, e.g., −3 V, but is not limited thereto, with respect to the common voltage Vcom, e.g., 0 V.

Further referring to FIG. 5B, a data voltage applied to the second original data line D2 during the first time period T1 is a negative polarity data voltage, e.g., −3 V, but is not limited thereto, with respect to the common voltage Vcom, e.g., 0 V, while an electric potential applied to the second original data line D2 during the second time period T2 is a positive polarity data voltage, e.g., 3 V, but is not limited thereto, with respect to the common voltage Vcom, e.g., 0 V.

Referring again to FIG. 5A, first through fourth transfer gates TG1-TG4, respectively, provide data voltages to first through fourth data lines D₁₁, D₁₂, D₂₁ and D₂₂, respectively, according to a selection control signal SEL and/or an inverted selection signal /SEL.

More specifically, referring to FIG. 5B, when the selection control signal SEL is high and the inverted selection control signal /SEL is low during the first time period T1, the first transfer gate TG1 and the fourth transfer gate TG4 are turned on, and a voltage from the first original data line D1 is thereby provided to the first data line D₁₁ and a voltage from the second original data line D2 is provided to the fourth data line D₂₂ during the first time period T1. Accordingly, during the first time period T1, 3 V is applied to the first data line D₁₁ and −3 V is applied to the fourth data line D₂₂. Further, the second and third data lines D₁₂ and D₂₂, respectively, are floated, and thus electrical potentials thereof may be, e.g., about 0 V, but are not limited thereto.

When the selection control signal SEL is low and the inverted selection control signal /SEL is high during the second time period T2, the second transfer gate TG2 and the third transfer gate TG3 are turned on, and the voltage from the first original data line D1 is provided to the second data line D₁₂ while the voltage from the second original data line D2 is provided to the third data line D₂₁ during the second time period T2. Accordingly, during the second time period T2, −3 V is applied to the second data line D₁₂ and 3 V is applied to the third data line D₂₁. Further, the first and fourth data lines D₁₁ and D₂₂, respectively, are floated, and thus the electrical potentials thereof may be, e.g., 0 V, but are not limited thereto.

Referring again to FIG. 5A, the data driver 500 may be integrated in the liquid crystal panel assembly 300 (FIG. 1) by an SOG method, as described above, for example, but is not limited thereto. In this case, the data driver 500 may be integrated together with the first through fourth transfer gates TG1-TG4, respectively.

Connection states of the first through fourth transfer gates TG1-TG4, respectively, the selection control signal SEL and the inverted selection control signal /SEL may vary in alternative exemplary embodiments. Accordingly, when the connection states of the first through fourth transfer gates TG1-TG4, respectively, the selection control signal SEL and the inverted selection control signal /SEL are different from those shown in FIG. 5A, waveforms of the signal output from the data driver 500 may be different from those shown in FIG. 5B without differing from the spirit and/or scope of the present invention.

Thus, as described later, the invention is not limited to the illustrated exemplary embodiments as described herein. For example, the first through fourth transfer gates TG1-TG4, respectively, may not be provided in alternative exemplary embodiments. Rather, the data driver 500 may provide data voltages directly to the first through fourth data lines D₁₁-D₂₂, respectively. In other words, the data driver 500 may perform functions of the first through fourth transfer gates TG1-TG4, respectively, in alternative exemplary embodiments of the present invention.

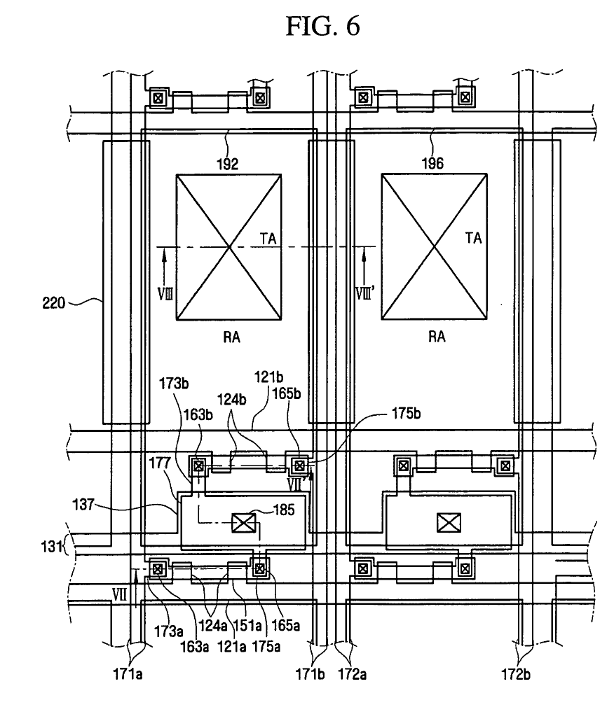

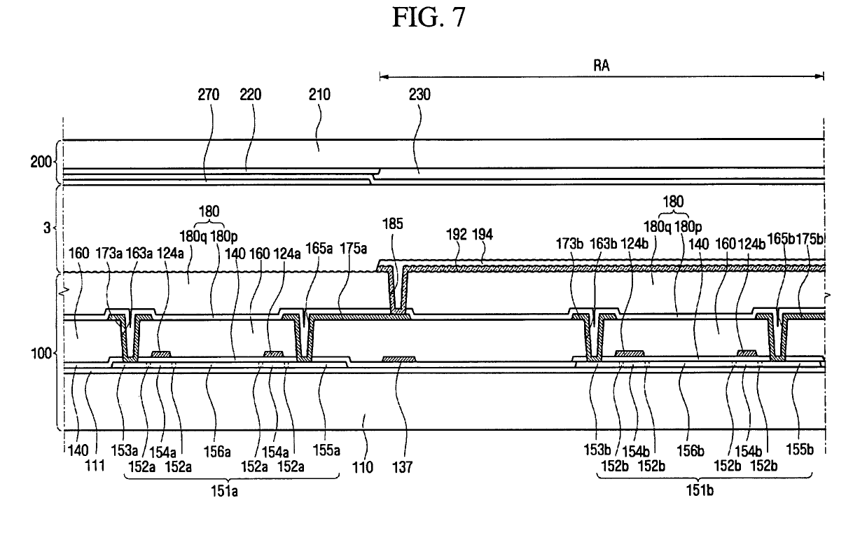

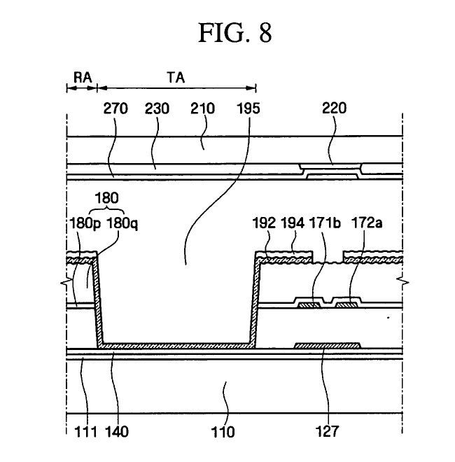

Hereinafter, a display substrate and an LCD including the same according to exemplary embodiments of the present invention will be described in further detail with reference to FIGS. 6 through 8. FIG. 6 is a plan layout view of a display substrate and an LCD including the display substrate according to an exemplary embodiment of the present invention, FIG. 7 is a partial cross-sectional view taken along line VII-VII′ of the display substrate and the LCD including the same according to the exemplary embodiment of the present invention in FIG. 6, and FIG. 8 is a partial cross-sectional view taken along line VIII-VIII′ of the display substrate and the LCD including the same according to the exemplary embodiment of the present invention in FIG. 6. For purposes of description, the exemplary embodiments will be described hereinafter with respect to two adjacent pixels of an LCD, as shown in FIG. 6. In addition, the exemplary embodiments will hereinafter be described as transmissive-reflective LCDs, but alternative exemplary embodiments of the present invention are not limited thereto. Furthermore, in the following description, a structure of a pixel including two switching elements coupling two respective gate lines and two respective data lines is shown and described, but alternative exemplary embodiments of the present invention are not limited thereto.

A first display panel 100, e.g., a display substrate according to an exemplary embodiment of the present invention, will now be described in further detail with reference to FIGS. 6 through 8.

A blocking film 111 made of silicon oxide (“SiO2”) or silicon nitride (“SiNx”), for example, but is not limited thereto, is formed on a transparent insulating substrate 110. The blocking film 111 may have a double layered structure, for example, but is not limited thereto.

A plurality of semiconductor islands 151a and 151b made of, e.g., polysilicon, but not being limited thereto, are formed on the blocking film 111. Semiconductor islands 151a and 151b of the plurality of semiconductor islands 151a and 151b include an extrinsic region containing conductive impurity, and an intrinsic region containing little conductive impurity in comparison with the extrinsic region of the semiconductor islands 151a and 151b. Further, an impurity region includes a heavily doped region and a lightly doped region.

Intrinsic regions of the respective semiconductor islands 151a and 151b include channel regions 154a and 154b. Heavily doped impurity regions include source regions 153a and 153b, intermediate regions 156a and 156b, and drain regions 155a and 155b, which are separated with respect to the channel regions 154a and 154b, as shown in FIG. 7. Lightly doped impurity regions 152a and 152b are disposed between each of the channel regions 154a and 154b and the source regions 153a and 153b, the drain regions 155a and 155b and the intermediate regions 156a and 156b, and a horizontal length of each of the lightly doped impurity regions 152a and 152b is relatively small compared to a horizontal length of the channel regions 154a and 154b, the source regions 153a and 153b, the drain regions 155a and 155b and the intermediate regions 156a and 156b, as illustrated in FIG. 7. The lightly doped impurity regions 152a and 152b are disposed between each of the source regions 153a and 153b, the channel regions 154a and 154b, and the drain regions 155a and 155b. The channel regions 154a and 154b are referred to as lightly doped drain (“LDD”) regions. For simplicity, formation of the LDD regions will be omitted herein.

The conductive impurities include P-type impurities such as boron (B) or gallium (Ga), and N-type impurities such as phosphorus (P) or arsenic (As), but are not limited thereto. The lightly doped impurity regions 152a and 152b prevent a leakage current or punch through from occurring at a thin film transistor, and can be replaced by offset regions without impurities, for example, in alternative exemplary embodiments.

A gate insulating layer 140 made of SiNx or SiO2, for example, is formed on the plurality of semiconductor islands 151a and 151b and the blocking film 111.

Gate lines 121a and 121b having gate electrodes 124a and 124b, a storage electrode line 131 and a light blocking pattern 127 are formed on the gate insulating layer 140.

The gate lines 121a and 121b transmit gate signals and extend in a first substantially transverse direction. The gate electrodes 124a and 124b extend upward from the gate lines 121a and 121b, and cross the semiconductor islands 151a and 151b, overlapping the respective channel regions 154a and 154b. Each of the gate lines 121a and 121b may have a pad (not shown) having a large area for connection with another layer or an outside driving circuit (not shown).

The storage electrode line 131 receives a predetermined voltage, e.g., a common voltage applied to a common electrode 270, which will be described in further detail later, and includes an extension 137 having an area which is relatively large compared to an area of the storage electrode line 131.

The light blocking pattern 127 is formed between adjacent pixel electrodes 192 and 196 and blocks light leakage.

The gate lines 121a and 121b, the storage electrode line 131 and the light blocking pattern 127 may be a metal containing aluminum (Al), such as Al or an Al alloy, a metal containing silver (Ag), such as Ag or an Ag alloy, a metal containing copper (Cu), such as Cu or a Cu alloy, a metal containing molybdenum (Mo), such as Mo or an Mo alloy, chromium (Cr), tantalum (Ta), titanium (Ti) or tungsten (W), for example, but is not limited thereto. Alternatively, the gate lines 121a and 121b and the storage electrode line 131 may have a multi-layered structure including two different conductive films (not shown) having different physical properties. Of the two different conductive films, one may be made of a low resistivity metal, such as a metal containing Al, a metal containing Ag, or a metal containing Mo, for example, and the other may be made of a material having good contact characteristics with other materials, for example, indium tin oxide (“ITO”), indium zinc oxide (“IZO”) or other similar material, such as a metal containing Mo, Cr, Ta or Ti, for example, but is not limited thereto. In an exemplary embodiment, the multi-layered structure includes two different conductive films such as a Cr lower film and an Al or Al alloy upper film, or an Al or Al alloy lower film and a Mo or Mo alloy upper film, for example, but is not limited thereto. In addition, the gate lines 121a and 121b may be made of other various metals and/or conductors in alternative exemplary embodiments of the present invention.

An interlayer insulating film 160 is formed on the gate lines 121a and 121b, the storage electrode line 131 and the light blocking pattern 127.

The interlayer insulating film 160 is made of an inorganic insulator such as silicon nitride or silicon oxide, an organic insulator, or a low dielectric insulating material, for example, but is not limited thereto. In an exemplary embodiment, a dielectric constant of the organic insulator or the low dielectric insulating material is about 4.0 or less, but is not limited thereto. Examples of the low dielectric insulating material include amorphous silicon (“a-Si”) to which carbon (C) and oxygen (O) have been added (“a-Si:C:O”) and a-Si to which O and fluorine (F) have been added (“a-Si:O:F”), for example, formed by plasma enhanced chemical vapor deposition (“PECVD”), but not being limited thereto. The interlayer insulating film 160 may be made of an organic insulator having photosensitivity and may be planarized, for example, but is not limited thereto in alternative exemplary embodiments of the present invention.

A plurality of contact holes 163a and 163b, and 165a and 165b exposing the source and drain regions 153a and 153b, and 155a and 155b, respectively, are formed through the interlayer insulating film 160 and the gate insulating layer 140.

Data lines 171a, 171b, 172a and 172b transmit data signals and extend substantially in a second longitudinal direction substantially perpendicular to the first direction.

A respective pair of the data lines 171a and 171b cross a respective pair of the gate lines 121a and 121b, and include source electrodes 173a and 173b connected to the source regions 153a and 153b through contact holes 163a and 163b, respectively.

In an exemplary embodiment, the data lines 171a and 171b overlap at least a portion of the light blocking pattern 127, as shown in FIG. 8. As described above, the light blocking pattern 127 prevents light leakage. Thus, the data lines 171a and 171b overlapping the light blocking pattern 127 improves an aperture ratio of the LCD. In one exemplary embodiment, as shown in FIG. 8, the light blocking pattern 127 is wide enough to completely overlap the data lines 171b and 172a, but is not limited thereto in alternative exemplary embodiments of the present invention.

The drain electrodes 175a and 175b are separated from the source electrodes 173a and 173b and are connected to the drain regions 155a and 155b through the contact holes 165a and 165b. The drain electrodes 175a and 175b include extensions 177 overlapping the extension 137 of the storage electrode line 131. The gate electrode 124a, the drain electrode 175a and the source electrode 173a constitute a switching element (e.g., switching element S1 of FIG. 2B), and the gate electrode 124b, the drain electrode 175b and the source electrode 173b constitute another switching element (e.g., switching element S2 of FIG. 2B).

In an exemplary embodiment, the data lines 171a, 171b, 172a and 172b which transmit data signals, the drain electrodes 175a and 175b and the extension 177 are made of a refractory metal such as Mo, Cr, Ta or Ti, or an alloy thereof, for example, but are not limited thereto. Alternatively, the data lines 171a, 171b, 172a and 172b which transmit data signals, the drain electrodes 175a and 175b and the extension 177 may have a multi-layer structure including a lower film made of a refractory metal and an upper film made of a low resistivity metal. Examples of the multi-layer structure include a double layered structure having a lower Cr or Mo or Mo alloy film and an upper Al or Al alloy film, and a triple layered structure having a lower Mo or Mo alloy film, an intermediate Al or Al alloy film and an upper Mo film, for example, but are not limited thereto in alternative exemplary embodiments of the present invention.

A passivation layer 180 is formed on the data lines 171a, 171b, 172a and 172b, the drain electrodes 175a and 175b, the source electrodes 173a and 173b and the interlayer insulating film 160.

The passivation layer 180 includes a lower film 180p made of an inorganic insulator such as silicon nitride or silicon oxide, for example, and an upper film 180q made of an organic insulator, for example, but neither being limited thereto. In an exemplary embodiment, the organic insulator has a dielectric constant of about 4.0 or less and may have photosensitivity. The upper film 180q of the passivation layer 180 has an opening partially exposing the lower film 180p of the passivation layer 180. Further, irregularities may be formed on a surface of the upper film 180q, producing an uneven surface. In alternative exemplary embodiments, the passivation layer 180 may have a single layered structure made of an inorganic insulator or an organic insulator.

A contact hole 185 exposing the extension 137 of the storage electrode line 131 is formed through the passivation layer 180, as shown in FIG. 7.

A plurality of the pixel electrodes 192 and 196 is formed on the passivation layer 180. A reflection film 194 is formed on each of the pixel electrodes 192 and 196. The pixel electrode 192 is made of a transparent conductive material such as ITO and indium zinc oxide IZO, and the reflecting film 194 is made of a reflective metal such as a metal containing Al, e.g., Al or an Al alloy, or a metal containing Ag, e.g., Ag or an Ag alloy. The reflection film 194 overlaps at least a portion of the gate line 121b, as shown in FIG. 7. The reflection film 194 may be positioned under a liquid crystal layer 3, and the reflection film 194 may be positioned under the pixel electrode 192, for example, in an exemplary embodiment.

The pixel electrode 192 and the reflection film 194 have uneven surfaces due to the irregularities formed on the upper film 180q of the passivation layer 180. The reflection film 194 has a transmission window 195 (FIG. 8) exposing the pixel electrode 192.

The pixel electrode 192 is electrically connected to the drain electrodes 175a and 175b through the contact hole 185, and receives data voltages from the drain electrodes 175a and 175b. After receiving the data voltages, the pixel electrode 192 creates an electric field with a common electrode 270 of a second display panel 200 provided with a common voltage, e.g., Vcom, thereby aligning liquid crystal molecules of the liquid crystal layer 3 between the pixel electrode 192 and the common electrode 270 according to the electric field created therebetween. Polarization of light passing through the liquid crystal layer 3 varies according to the alignment of the liquid crystal molecules of the liquid crystal layer 3.

The LCD according to an exemplary embodiment of the present invention includes a transmission area TA and a reflection area RA defined by the pixel electrode 192 and the reflection film 194. More specifically, the transmission window 195, e.g., where the reflection film 194 is not formed (FIG. 8), is the transmission area TA, and an area having both the pixel electrode 192 and the reflection film 194 is the reflection area RA (FIGS. 7 and 8).

Furthermore, the transmission area TA is a plurality of portions of the LCD disposed on and under an exposed portion of the pixel electrode 192 in the TFT array panel 100, the common electrode panel 200, and the LC layer 3, e.g., portions not on or under the reflection film 194, while the reflection area RA is a plurality of portions of the LCD disposed on and under the reflection film 194. In the transmission areas TA, incident light emitted from the rear of the LCD, successively passes through the first display panel 100 and the liquid crystal layer 3 and then exits the second display panel 200, thus displaying an image. In the reflection areas RA, outside light, supplied through the front of the LCD, successively passes through the second display panel 200 and the liquid crystal layer 3 and is then reflected back towards the front of the LCD by the reflection film 194 of the first display panel 100. After the reflection, the light passes back through the liquid crystal layer 3 again and then exits the second display panel 200, thus displaying an image.

A black matrix 220 is provided on an insulating substrate 210 made of an insulating material such as transparent glass or plastic. The black matrix 220 prevents light from leaking out through portions between the pixel electrodes 192 and 196, and substantially defines a pixel region, e.g., the pixel region is an area of the LCD not covered by the black matrix 220.

As shown in FIG. 8, the black matrix 220 may overlap at least a portion of each of the data lines 171b and 172a. The greater the overlapping area is, the better the aperture ratio becomes.

Exemplary embodiments of the present invention have been described wherein the LCD includes both the light blocking pattern 127 provided on the first display panel 100 and the black matrix 220 provided on the second display panel 200. However, alternative exemplary embodiments of the present invention are not limited thereto, and an LCD may include either one of the light blocking pattern 127 and the black matrix 220.

A plurality of color filters 230 are formed on the substrate 210 and the black matrix 220 and are disposed to overlap the pixel area, as shown in FIGS. 7 and 8.

In a display substrate and an LCD including the same according to an exemplary embodiment of the present invention, data lines to which positive polarity data voltages are applied and data lines to which negative polarity data voltages are applied are separate and distinct from each other. Accordingly, a variation in the voltage between each of the respective data lines is small, thereby effectively reducing power consumption of the LCD.

In addition, in an LCD having a pixel structure having two gate lines and two data lines according to exemplary embodiments of the present invention, an aperture ratio of the LCD is improved, since each of the gate lines overlaps at least a portion of a reflection film and each of the data lines overlaps at least a portion of a light blocking pattern and/or a black matrix.

Thus, according to exemplary embodiments of the present invention as described herein, a display substrates and an LCD including the same have reduced power consumption while improving an aperture ratio thereof.

The present invention should not be construed as being limited to the exemplary embodiments set forth herein. Rather, these exemplary embodiments are provided so that this disclosure will be thorough and complete and will fully convey the concept of the present invention to those skilled in the art. It is therefore desired that the exemplary embodiments described herein be considered in all respects as illustrative and not restrictive.

Further, while the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A liquid crystal display comprising:
a first positive data line and a second positive data line, each of which supplies a positive polarity data voltage;
a first negative data line and a second negative data line, each of which supplies a negative polarity data voltage;
a first pixel connected to first and second gate lines, wherein the first pixel is supplied with a positive polarity data voltage from the first positive data line when the first pixel is enabled by a first gate-on voltage from the first gate line, and the first pixel is supplied with a negative polarity data voltage from the first negative data line when the first pixel is enabled by a second gate-on voltage from the second gate line; and
a second pixel connected to the first gate line and the second gate line, wherein the second pixel is supplied with a negative polarity data voltage from the second negative data line when the second pixel is enabled by the first gate-on voltage from the first gate line, and the second pixel is supplied with a positive polarity data voltage from the second positive data line when the second pixel is enabled by the second gate-on voltage from the second gate line.

2. The liquid crystal display of claim 1, wherein an electric potential of the positive polarity data voltage is positive with respect to an electric potential of a direct current common voltage and an electric potential of the negative polarity data voltage is negative with respect to an electric potential of the direct-current common voltage.

3. The liquid crystal display of claim 1, wherein the first pixel and the second pixel each comprises:
a first switching element enabled by the first gate-on voltage;
a second switching element enabled by the second gate-on voltage; and
a pixel electrode connected to the first switching element and the second switching element, wherein the positive polarity data voltage or the negative polarity data voltage is applied to the pixel electrode through the first switching element or the second switching element.

4. The liquid crystal display of claim 2, wherein the first pixel and the second pixel each comprises:
a first switching element enabled by the first gate-on voltage;
a second switching element enabled by the second gate-on voltage;
a pixel electrode connected to the first switching element and the second switching element, wherein the positive polarity data voltage or the negative polarity data voltage is applied to the pixel electrode through the first switching element or the second switching element;
a common electrode opposite to and facing the pixel electrode and to which the direct current common voltage is applied;
a liquid crystal layer interposed between the pixel electrode and the common electrode; and
a reflection film disposed between the pixel electrode and the liquid crystal layer.

5. The liquid crystal display of claim 4, wherein the reflection film overlaps at least a portion of at least one of the first gate line and the second gate line.

6. The liquid crystal display of claim 4, further comprising:
a substrate, wherein the first gate lines and the second gate lines are formed on the substrate; and
a light blocking pattern formed on the substrate between adjacent pixel electrodes, wherein at least a portion of the light blocking pattern overlaps either the first positive data line or the first negative data line and either the second positive data line or the second negative data line.

7. The liquid crystal display of claim 4, further comprising a black matrix disposed on the common electrode, wherein at least a portion of the black matrix overlaps either the first positive data line or the first negative data line and either the second positive data line or the second negative data line.

8. The liquid crystal display of claim 1, wherein when the positive polarity data voltage is supplied from the first positive data line, the first negative data line is floated, and when the negative polarity data voltage is supplied from the first negative data line, the first positive data line is floated.

9. The liquid crystal display of claim 1, further comprising:
a data driver which provides the positive polarity data voltage to the first positive data lines and the second positive data lines or the negative data voltage to the first negative data lines and the second negative data lines according to an image signal; and
a plurality of transfer gates which provides the first positive data line and the second positive data line with the positive polarity data voltage when the positive polarity data voltage is provided from the data driver, and provides the first negative data line and the second negative data line with the negative polarity data voltage when the negative polarity data voltage is provided from the data driver.

10. The liquid crystal display of claim 9, wherein the transfer gates do not provide the first and second negative data lines with the positive polarity data voltage when the positive polarity data voltage is provided from the data driver, and do not provide the first and second positive data lines with the negative polarity data voltage when the negative polarity data voltage is provided from the data driver.

11. The liquid crystal display of claim 1, further comprising:
a third gate line and a fourth gate line;
a third pixel connected to the third gate line and the fourth gate line, the first positive data line and the first negative data line, wherein the third pixel is supplied with a positive polarity data voltage from the first positive data line when the third pixel is enabled by a third gate-on voltage from the third gate line, and wherein the third pixel is supplied with a negative polarity data voltage from the first negative data line when the third pixel is enabled by a fourth gate-on voltage from the fourth gate line; and
a fourth pixel connected to the third gate line and the fourth gate line, the second positive data line and the second negative data line, wherein the fourth pixel is supplied with a negative polarity data voltage from the second negative data line when the third pixel is enabled by a third gate-on voltage from the third gate line, and wherein the fourth pixel is supplied with a positive polarity data voltage from the second positive data line when the fourth pixel is enabled by a fourth gate-on voltage from the fourth gate line.

12. The liquid crystal display of claim 1, further comprising:
a third gate line and a fourth gate line;
a third pixel connected to the third gate line and the fourth gate line, the first positive data line and the first negative data line, wherein the third pixel is supplied with a negative polarity data voltage from the first negative data line when the third pixel is enabled by a third gate-on voltage from the third gate line, and wherein the third pixel is supplied with a positive polarity data voltage from the first positive data line when the third pixel is enabled by a fourth gate-on voltage from the fourth gate line; and
a fourth pixel connected to the third gate line and the fourth gate line, the second positive data line and the second negative data line, wherein the fourth pixel is supplied with a positive polarity data voltage from the second positive data line when the fourth pixel is enabled by a third gate-on voltage from the third gate line, and wherein the fourth pixel is supplied with a negative polarity data voltage from the second negative data line when the fourth pixel is enabled by a fourth gate-on voltage from the fourth gate line.

13. The liquid crystal display of claim 1, wherein the first gate-on voltage and the second gate-on voltage are each provided in different frames of a plurality of frames of the liquid crystal display.

14. A display substrate comprising:
an insulating substrate;
a first gate line and a second gate line formed on the insulating substrate;
a first data line and a second data line formed on the insulating substrate and each crossing the first and second gate lines;
a first thin film transistor connected to the first gate line and the first data line and having a first drain electrode;
a second thin film transistor connected to the second gate line and the second data line and having a second drain electrode;
a first pixel electrode connected to the first drain electrode and the second drain electrode; and
a reflection film, wherein at least a portion of the reflection film overlaps at least a portion of the first pixel electrode.

15. The display substrate of claim 14, wherein the reflection film overlaps at least a portion of one of the first gate line and the second gate line.

16. The display substrate of claim 14, wherein the first pixel electrode is disposed between the first data line and the second data line.

17. The display substrate of claim 14, further comprising a light blocking pattern formed on the insulating substrate, wherein at least a portion of the light blocking pattern overlaps at least a portion of one of the first data line and the second data line.

18. The display substrate of claim 14, wherein when a data voltage is applied to the first data line, the second data line is floated.

19. The display substrate of claim 14, further comprising:
a third data line and a fourth data line;
a third thin film transistor connected to the first gate line and the third data line and having a third drain electrode;
a fourth thin film transistor connected to the second gate line and the fourth data line and having a fourth drain electrode; and
a second pixel electrode connected to the third drain electrode and the fourth drain electrode.

20. The display substrate of claim 19, wherein the first pixel electrode is disposed between the first data line and the second data line and the second pixel electrode is disposed between the third data line and the fourth data line.

21. The display substrate of claim 19, further comprising a light blocking pattern formed on the insulating substrate disposed between the first pixel electrode and the second pixel electrode, wherein at least a portion of the light blocking pattern overlaps at least a portion of one of the first data line and the second data line and one of the third data line and the fourth data line.
